(19) United States
(12) Patent Application Publication
(10) Pub. No.: US 2008/0065854 A1
(43) Pub. Date: Mar. 13, 2008

(54) Method and apparatus for accessing physical memory belonging to virtual machines from a user level monitor

(76) Inventors: Sebastina Schoenberg, Hillsboro, OR (US); Udo Steinberg, Sohland a.d. Spree (DE); Alain Kaegi, Portland, OR (US); Tariq Masood, Portland, OR (US); Philip Lantz, Cornelius, OR (US); Andrew V. Anderson, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/517,668

(22) Filed: Sep. 7, 2006

(51) Int. Cl. G06F 12/00; G06F 13/00; G06F 9/34

(52) U.S. Cl. 711/203; 711/147; 710/22

(57) ABSTRACT

A processing system may include a service operating system (OS) and a guest virtual machine (VM). The service OS may be a host OS or an OS in a service VM, for instance. The guest VM may have a physical address space. In one embodiment, a pseudo-device driver in the service OS causes an address within the physical address space of the guest VM to be mapped to an address within a virtual address space of a user level monitor (ULM) running on top of the service OS. When an operation that involves the physical address space of the guest VM (e.g., a direct memory access (DMA) operation requested by the guest VM, an interrupt triggered by the guest VM, etc.) is detected, the ULM may use its virtual address space to access the physical address space of the guest VM. Other embodiments are described and claimed.

### FIELD OF THE INVENTION

The present disclosure relates generally to the field of data processing, and more particularly to methods and related apparatus to allow a user level monitor to access physical memory belonging to virtual machines of a processing system.

### BACKGROUND

A data processing system typically includes various hardware resources (e.g., memory and one or more processing units) and software resources (e.g., an operating system (OS) and one or more user applications). In addition, it is sometimes possible to configure a single data processing system to include two or more distinct environments, each of which operates as if it were an independent data processing system, at least as far as the OSs and applications running in those environments are concerned. The physical data processing system may be referred to as a physical machine, and the independent environments within that physical machine may be referred to as virtual machines (VMs). The software that creates and manages the VMs may be referred to as the virtual machine monitor (VMM).

Different types of VMMs have been developed, including monolithic VMMs, hosted VMMs, and hybrid VMMs. A monolithic VMM is like an OS that also includes the capability of creating and managing guest VMs. For instance, a typical monolithic VMM includes all of the device drivers necessary for communicating with the physical devices of the processing system. In addition, the VMM may create virtual devices for the guest VMs to use. The virtual devices may be referred to as device models. The device drivers in the OS of each guest VM may communicate with those device models, and the VMM may in turn communicate with the physical devices. For example, a VMM may create a first virtual network interface for a first guest VM and a second virtual network interface for a second guest VM, but the VMM may actually use the same physical network interface to service those two virtual network interfaces.

Unlike a monolithic VMM, a hosted VMM runs as an application (known as a user level monitor or ULM) on top of a conventional OS. The components of the ULM execute as user-level code in the host OS. The ULM may include all or most of the device models that the guest VMs use as devices. The ULM may handle most of the virtualization services. A hosted VMM may use the device drivers of the host, as well as other services of the host OS, such as memory management and process scheduling. Typically, hosted and hybrid VMMs will also contain system-level components (e.g., device drivers) to allow the VMM to more fully exploit the capabilities of the processor.

A hybrid VMM includes a hypervisor that runs at a low logical level, and a service OS (e.g., Linux) that runs on top of the hypervisor, with less privilege than the hypervisor, in a virtual machine known as a service VM. As in a hosted VMM, the hybrid VMM runs an application known as a ULM. The components of the ULM execute as user-level code in the service OS. The ULM may include all or most of the device models that the guest VMs use as devices. The ULM may handle most of the virtualization services and as a consequence may use services of device drivers in the service OS for interacting with the physical devices of the processing system. For example, the ULM may use a device driver in the service OS to retrieve data from a physical storage device in response to a VM attempting to read from a virtual storage device.

The hypervisor may be a relatively small component that typically runs in the most privileged mode (e.g., in ring 0 or in virtual machine extensions (VMX) root mode), and it may be used to enforce protection and isolation. (Additional information about VMX root mode is currently available at www.intel.com/technology/itj/2006/v10i3/3-xen/3-virtualization-technology.htm.) A partition manager may also run on top of the hypervisor. The partition manager may act as the resource manager for the platform, and it may virtualize various aspects of the VM in which the service OS runs.

Like monolithic VMMs, hosted VMMs and hybrid VMMs can create guest VMs, each of which may include a guest OS and user applications.

One challenging aspect of designing a VMM is to provide effective security. For instance, a VMM typically should not allow a VM to read or modify the storage areas of the VMM, or the storage areas of any of the other VMs.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting a suitable data processing environment in which certain aspects of an example embodiment of the present invention may be implemented;

FIG. 2 is a flowchart depicting various aspects of a process for accessing physical memory belonging to a virtual machine, according to an example embodiment of the present invention; and

FIG. 3 is a block diagram depicting example memory regions, according to an example embodiment of the present invention.

### DETAILED DESCRIPTION

For some VMMs, such as a hybrid VMM, the VMM may be decomposed into a small privileged component called the hypervisor, micro-hypervisor, or kernel, and one or more de-privileged components implementing specific aspects of the VMM. The de-privileged component(s) may be built from scratch or built upon existing system software, such as a conventional OS. When the de-privileged components are built upon an existing OS, the VMM can reuse the driver and resource management support in the OS. However, the OS would still run de-privileged, at least in the hybrid model. Such system software may be called a service OS, and the de-privileged component built upon it, the user level monitor (ULM).

Similarly, in the hosted VMM model, while the host OS may not run deprivileged with respect to the VMM, the host OS may play a similar role and can be treated as a service OS to the VMM. Accordingly, a host OS may also be referred to as a service OS.

To provide virtualization services to guest VMs, the ULM must be able to access physical memory belonging to them. However, since the ULM is a user-level component running in an OS (which is itself de-privileged in the case of a hybrid model), the ULM may be unable to access guest physical memory (GPM) without additional support.

This document describes one or more example methods and apparatus for providing a ULM in the service OS with access to the complete GPM or portions of the GPM of guest VMs. In addition, when the ULM no longer needs access to the GPM, the ULM may free the resources that had been allocated to allow such accesses. Embodiments of the invention may thus allow efficient memory usage in the ULM and service OS. Also, embodiments may involve relatively low software overhead, and relatively low complexity in the overall VMM.

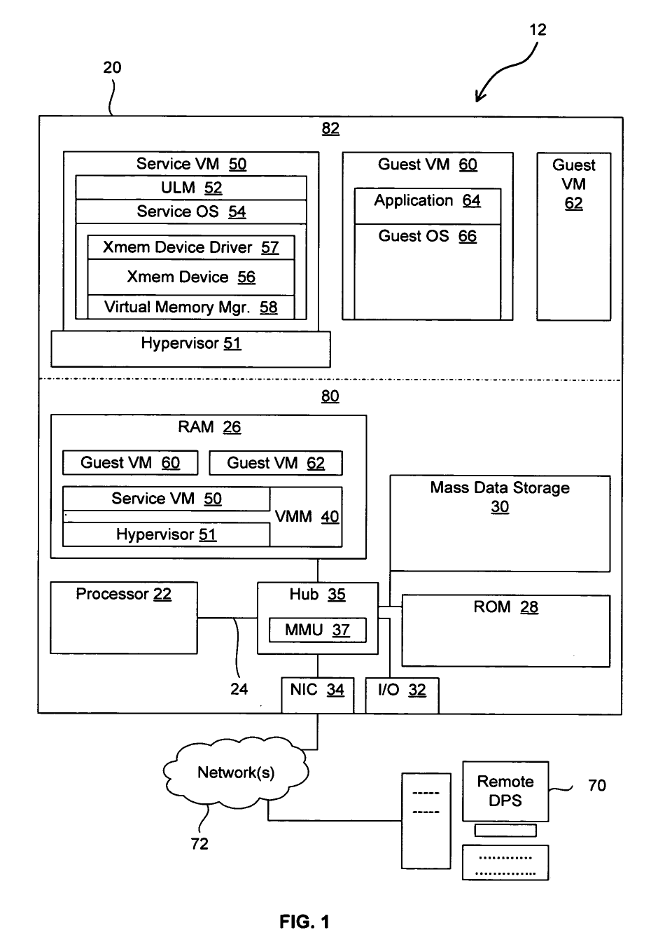

FIG. 1 is a block diagram depicting a suitable data processing environment 12 in which certain aspects of an example embodiment of the present invention may be implemented. Data processing environment 12 includes a processing system 20 that includes various hardware components 80 and software components 82. The hardware components may include, for example, one or more processors or CPUs 22, communicatively coupled, directly or indirectly, to various other components via one or more system buses 24 or other communication pathways or mediums. Processor 22 may include one or more processing cores or similar processing units. Alternatively, a processing system may include multiple processors, each having at least one processing unit. The processing units may be implemented as processing cores, as hyper-threading (HT) resources, or as any other suitable technology for executing multiple threads simultaneously or substantially simultaneously.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers (PCs), workstations, servers, portable computers, laptop computers, tablet computers, personal digital assistants (PDAs), telephones, handheld devices, entertainment devices such as audio and/or video devices, and other devices for processing or transmitting information.

Processing system 20 may be controlled, at least in part, by input from conventional input devices, such as a keyboard, a pointing device such as a mouse, etc. Input devices may communicate with processing system 20 via an I/O port 32, for example. Processing system 20 may also respond to directives or other types of information received from other processing systems or other input sources or signals. Processing system 20 may utilize one or more connections to one or more remote data processing systems 70, for example through a network interface controller (NIC) 34, a modem, or other communication ports or couplings. Processing systems may be interconnected by way of a physical and/or logical network 72, such as a local area network (LAN), a wide area network (WAN), an intranet, the Internet, etc. Communications involving network 72 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc.

Within processing system 20, processor 22 may be communicatively coupled to one or more volatile or non-volatile data storage devices, such as RAM 26, read-only memory (ROM) 28, and one or more mass storage devices 30. The mass storage devices 30 may include, for instance, integrated drive electronics (IDE), small computer system interface (SCSI), and serial advanced technology architecture (SATA) hard drives. The data storage devices may also include other devices or media, such as floppy disks, optical storage, tapes, flash memory, memory sticks, compact flash (CF) cards, digital video disks (DVDs), etc. For purposes of this disclosure, the term “ROM” may be used in general to refer to non-volatile memory devices such as erasable programmable ROM (EPROM), electrically erasable programmable ROM (EEPROM), flash ROM, flash memory, etc.

Processor 22 may also be communicatively coupled to additional components, such as one or more video controllers, SCSI controllers, network controllers, universal serial bus (USB) controllers, I/O ports, input devices such as a camera, etc. Processing system 20 may also include one or more bridges or hubs 35, such as a memory controller hub (MCH), an input/output control hub (ICH), a peripheral component interconnect (PCI) root bridge, etc., for communicatively coupling system components. As used herein, the term “bus” includes pathways that may be shared by more than two devices, as well as point-to-point pathways.

Some components, such as NIC 34, for example, may be implemented as adapter cards with interfaces (e.g., a PCI connector) for communicating with a bus. Alternatively, NIC 34 and other devices may be implemented as on-board or embedded controllers, using components such as programmable or non-programmable logic devices or arrays, application-specific integrated circuits (ASICs), embedded processors, smart cards, etc.

The invention may be described herein with reference to data such as instructions, functions, procedures, data structures, application programs, configuration settings, etc. When the data is accessed by a machine, the machine may respond by performing tasks, defining abstract data types or low-level hardware contexts, and/or performing other operations, as described in greater detail below. The data may be stored in volatile and/or non-volatile data storage. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by a processing system, perform a desired operation or operations.

For instance, ROM 28, data storage device 30, and/or RAM 26 may include various sets of instructions which, when executed, perform various operations. Such sets of instructions may be referred to in general as software. In the embodiment of FIG. 1, RAM 26 includes a VMM 40 and guest VMs 60 and 62. Processing system 20 may load such software components into RAM 26 from nonvolatile storage such as mass data storage 30, ROM 28, or any other suitable storage device(s), including remote storage devices. Also, in the embodiment of FIG. 1, VMM 40 includes a service VM 50 and a hypervisor or micro-hypervisor 51.

As illustrated within block 82, those software components may include various subcomponents. For example, guest VM 60 may include an application 64 and a guest OS 66. Service VM 50 may include a ULM 52 that runs on top of a service OS 54. Service OS 54 may include a virtual memory manager 58.

Service OS 54 may also include a memory pseudo-device driver (i.e., a pseudo-device driver that acts as a memory interface). For purposes of this disclosure, pseudo-device drivers are parts of the OS that act like device drivers, but do not directly correspond to any actual device in the machine. In the example embodiment, the memory pseudo-device driver 56 is referred to as Xmem device 56. As described in greater detail below, Xmem device 56 serves as a device for ULM 52, allowing ULM 52 to map one or more portions of its virtual address space to host physical addresses of other VMs.

VMM 40 may provide virtualized physical memory for each guest VM. This “virtualized physical memory” should not be confused with the “virtual memory” that the guest OS in each VM may create, based on the virtualized physical memory.

In particular, a VMM may see the host physical address (HPA) space, which may directly correspond to all, or almost all, of the physical RAM in a processing system. Access to the physical RAM may be controlled by a memory management unit (MMU), such as MMU 37 in hub 35. However, the OS in each VM may not see the host physical memory (HPM), but may instead see the virtualized physical memory that is provided by the VMM. This virtualized physical memory may also be referred to as guest physical memory (GPM), since the OS in the guest VM operates as if the virtualized physical memory were physical memory for that the VM. The OS in the guest VM, in turn, uses the GPM to provide virtual memory for use by software in the guest VM.

For instance, with regard to service VM 50, ULM 52 only sees the virtual memory provided to it by service OS 54. Also, service OS 54 may only see the GPM provided for service VM 50 by hypervisor 51. In other words, hypervisor 51 may make the GPM of service VM 50 visible to service OS 54, and service OS 54 may make portions of that memory visible to ULM 52 through the ULM's virtual address space (VAS).

For purposes of this disclosure, memory is considered visible to a VM if the memory can be detected by software in that VM. Typically, if a component attempts to access a memory address that is not visible to that component, the result will be the same kind of result that would be obtained on a bare (i.e., non-virtualized) platform when attempting to access physical memory that is not present on that platform.

However, as part of providing virtualization services, ULM 52 may regularly need to access GPM of other VMs and possibly that of service VM 50. Examples of such virtualization services are emulation of BIOS disk services, emulation of I/O devices requiring access to guest physical memory, and emulation of a privileged instruction in a guest VM. For instance, ULM 52 may need to access GPM of guest VM 60 to emulate a direct memory access (DMA) operation for a virtual hard disk drive of guest VM 60. However, to ensure isolation and protection for VMs in a hybrid model, VM 50, service OS 54, and hence ULM 52 are not to be allowed access to a given region of another guest VM's GPM natively.

This disclosure describes an efficient way for a ULM to access some or all of the GPM of one or more guest VMs. Additionally, when the ULM no longer needs access to GPM, it can free the resources that had been allocated to allow such accesses. Embodiments of the invention may allow efficient memory usage in a ULM and a service OS, with low software overhead and complexity in the overall VMM, while maintaining isolation and protection.

As described in greater detail below, the ULM may use its own virtual address space to access the physical memory of a guest VM. This feat is made possible, at least in part, by the Xmem device, which creates address translation tables in the service OS to map a portion, multiple portions, or all of the GPM of another VM to portions of the virtual address space of the ULM.

In a hybrid model where the ULM runs within a service VM and the Xmem device runs as part of the service OS kernel, the underlying hypervisor (which typically virtualizes MMUs for VMs) cooperates with the service VM to allow the Xmem device to map apertures into physical memory of other VMs. For example, when the ULM uses the Xmem device to access the memory of another VM, the Xmem device may call the hypervisor to set up permissions to access that memory.

In one embodiment, the hypervisor configures the system so that memory pages assigned to other guests or used for VMM-specific data structures are accessible from the service VM. The Xmem device may then enable access to these regions by appropriately configuring the guest's page tables.

In one embodiment, the ULM or Xmem device communicates to the hypervisor the memory to be accessed, specified either in terms of a platform physical specification (which may correspond to the physical address space of the underlying hardware) or a virtualized address space presented to the ULM. As a result of this communication, the hypervisor will add or remove access to the requested memory resource through an access aperture.

In one hosted VMM embodiment, a VMM component may request memory resources from the host OS. Once the memory resources are appropriately reserved (e.g., allocated and pinned through an appropriate OS service), the VMM may manage this pool of memory to provide resources for various VMs.

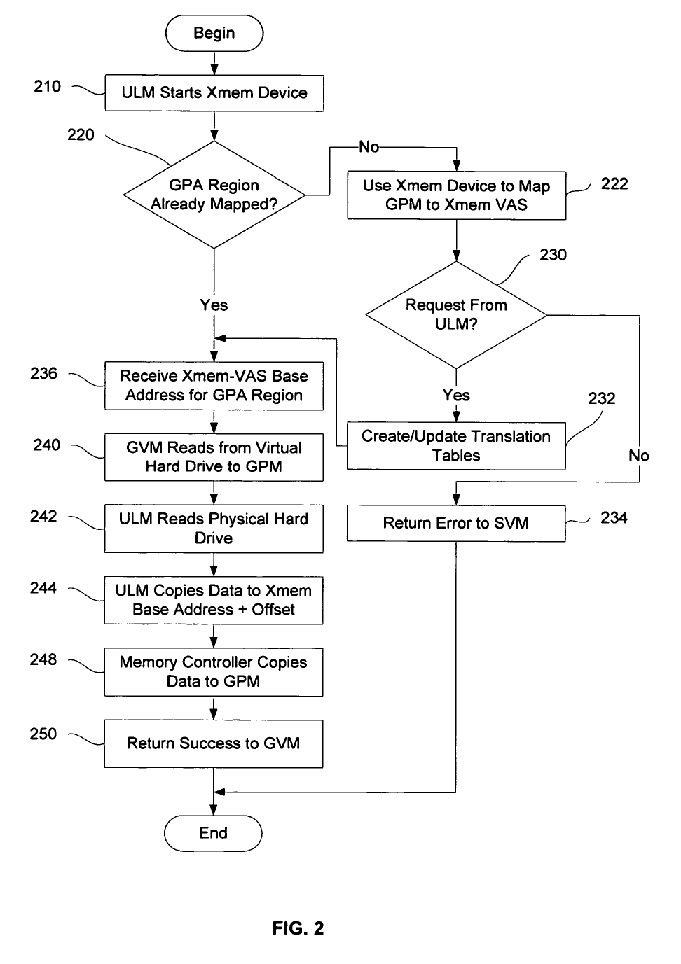

In an example embodiment, Xmem device 56 runs as a kernel module in service OS 54, and Xmem device 56 exposes the capability to access GPM as a device or file, as described in greater detail below with respect to FIG. 2. A user-level process, such as ULM 52, can then use standard device or file access methods to request the Xmem device 56 to map GPM into the virtual address space of ULM 52. Additional details are provided below with regard to FIG. 2.

The addresses from the virtual address space of ULM 52 that Xmem device 56 has mapped to GPM may be referred to as the Xmem VAS. The beginning address of an Xmem VAS may be referred to as the Xmem-VAS base address. An Xmem VAS may be considered a VAS aperture into GPM. As described in greater detail below, after the mapping has been performed, when ULM 52 accesses the Xmem VAS, MMU 37 (or other facilities for providing processor paging support) converts those accesses to GPM accesses. ULM 52 can request Xmem device 56 to create translation table entries for specified portions of GPM or for all GPM of a VM. Later, when ULM 52 no longer needs access to a GPM region, it can request Xmem device 56 to free the associated resources.

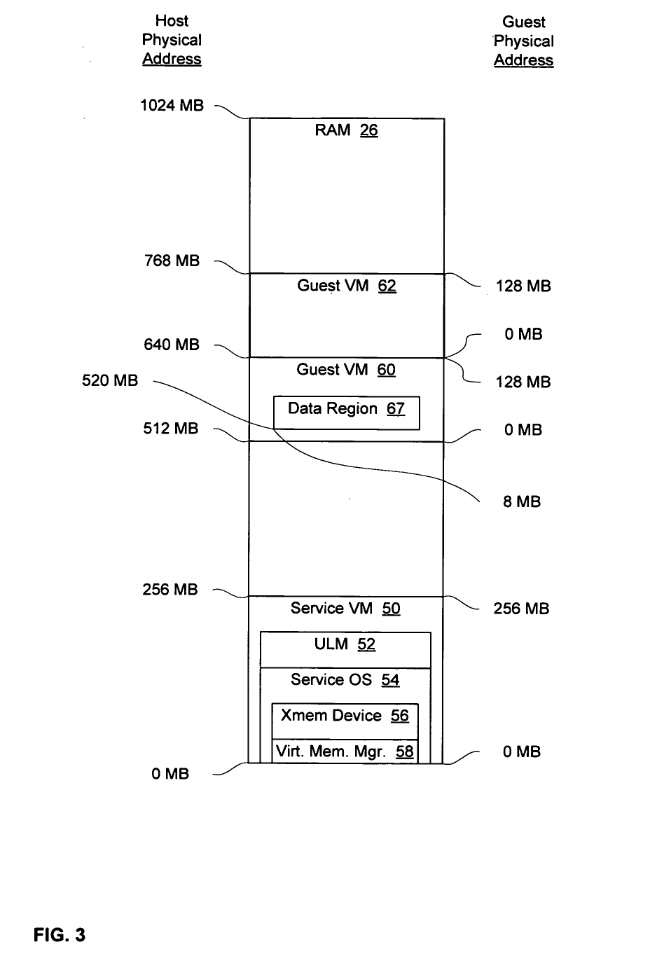

FIG. 2 is a flowchart depicting various aspects of a process for accessing physical memory belonging to a virtual machine, according to an example embodiment of the present invention. The process of FIG. 2 is discussed with regard also to FIG. 3, which depicts example memory regions used by the VMs of FIG. 1.

In the embodiment of FIG. 1, when ULM 52 creates VM 60 and VM 62, ULM 52 records the base address of each guest VM within the host physical address space. For instance, with respect to FIG. 3, ULM 52 may record that guest VM 60 starts at HPA 512 megabytes (MB), and guest VM 62 starts at HPA 640 MB. ULM 52 may also record that guest VM 60 spans 128 MB and guest VM 62 spans 128 MB.

In the embodiments of FIGS. 1-3, ULM 52 uses Xmem device 56 to create translation tables to map GPM of all guest VMs before GPM access is required. In other embodiments, the ULM may wait until GPM access is required before using the Xmem device.

FIG. 2 illustrates an example process in which ULM 52 uses Xmem device 56 to get access to the GPM address space of guest VM 60. Similar operations may be used to provide ULM 52 with access to the GPM of guest VM 62. The process of FIG. 2 may start after processing system 20 has booted and service VM 50 and guest VMs 60 and 62 are running. At block 210, ULM 52 may instantiate Xmem device 56, possibly in response to a determination that ULM 52 needs to access all or part of the GPM of guest VM 60. Alternatively, Xmem device 56 can be instantiated before ULM 52 starts.

With regard to FIG. 3, to support access to all of the GPM of guest VM 60, ULM 52 may specify 512 MB as the HPA to be mapped, and 128 MB as the size of the region to be mapped. The corresponding starting address within the GPM of guest VM 60 (e.g., guest physical address 0) may be referred to as the guest base address. It may also be noted that HPA 512 MB is considered to be not visible to service VM 50 because that address is outside of the HPM region allocated to service VM 50 (which, in the example embodiment, is the region from 0 MB to 256 MB). Alternatively, to support access to only a portion of guest VM 60, such as data region 67, ULM 52 may add an offset (e.g., 8 MB) to the base HPA to form the HPM base address for the GPM region to be mapped.

As shown at block 220, ULM 52 may then determine whether the relevant portion of the GPM of guest VM 60 has already been mapped. If the mapping has not already been performed, ULM 52 uses Xmem device 56 to map a predetermined host physical address space, starting at a specified host physical address and extending for a specified size or offset, as shown at block 222. As indicated below, the mapping system call and Xmem device 56 may work together to return a corresponding Xmem-VAS base address for use by ULM 52.

However, as indicated at block 230, whenever Xmem device 56 is called upon to map HPM to guest virtual memory, Xmem device 56 may authenticate the entity making the system call, to ensure that only ULM 52 uses the services of Xmem device 56. If an unauthorized entity is detected, Xmem device 56 may return an error, as indicated at block 234. Authentication may be provided through the use of a ‘cookie’, through runtime checks of the calling entity (e.g., the code sequence of the calling application matching a specific cryptographic signature), or through any other suitable mechanism. Invocation of hypervisor interfaces for altering memory maps may also be restricted to a subset of VMs (due to system configuration or dynamic component registration).

As depicted at block 232, if the requesting entity passes authentication, Xmem device 56 may create translation tables to map the specified GPM region to a ULM-visible address range. As indicated at block 236, once the necessary translation table entries have been created, mapping of Xmem device 56 may return the Xmem-VAS base address that has been mapped to the specified GPM address. For instance, Xmem device 56 may use low level OS services, such as those indicated below, to create translation table entries that will provide access to the HPA region starting at HPA 512 MB when ULM 52 references kernel virtual addresses starting at the Xmem-VAS base address of 128 MB. Also, the extent of the mapped region may correspond to the specified size (e.g., 64 MB).

For instance, an implementation under the Linux OS may include the following steps: The ULM opens the Xmem device (XD) and records the handle (or OS descriptor for the XD). Then the ULM maps the XD using that handle, and specifying the desired host physical memory range. This mapping is performed via a system call such as mmap. The mmap system call is converted to an input/output control (IOCTL) method call into the XD driver (XDD). The XDD calls a function such as ‘map_pfn range’ to map the host physical memory range passed to it with the IOCTL, and returns an Xmem-VAS base address to be used by the ULM.

By allowing mapping of the relevant portion of the GPM of guest VM 60 to an address within the VAS of ULM 52, Xmem device 56 makes it possible for ULM 52 to access GPM locations that would otherwise not be visible to or managed by Service VM 50 or ULM 52. Consequently, ULM 52 may use the Xmem VAS to access the GPM of guest VM 60. In particular, ULM 52 may access a given GPM address within guest VM 60 (e.g., “guest address A”) by determining the distance from that address to the guest base address, and adding that distance to the Xmem-VAS base address. (E.g., [Xmem-VAS base address]+([guest address A]−[guest base address].)

For instance, as indicated at block 240, guest VM 60 may execute instructions for using DMA to read from a hard disk drive to data region 67 in the virtual memory of guest VM 60. However, guest VM 60 isn't actually a distinct physical machine. Instead, VMM 40 interacts with guest VM 60 in a manner that allows the software in guest VM 60 to operate as if guest VM 60 were an independent physical machine. Accordingly, when guest VM 60 executes the instructions for reading from a virtual hard disk drive using DMA, those instruction may cause ULM 52 to read a physical hard disk drive (or other mass storage device 30), as indicated at block 242.

As shown at block 244, to complete the virtual DMA aspect of the requested operations, ULM 52 may copy the data that was read to an address associated with Xmem device 56. Specifically, if guest VM 60 executed instructions to use DMA to store the data beginning at guest physical address 8 MB, and Xmem device 56 was configured to map Xmem-VAS base address to HPA 512 MB, ULM 52 may actually copy the data that was read to Xmem-VAS base address plus 8 MB. Consequently, when MMU 37 walks the page tables referenced above, MMU 37 ends up storing the data at HPA 520 MB, as depicted at block 248. Service OS 54 may then report to ULM 52 that the copy operation has completed, and ULM 52 may report to guest VM 60 that the disk read has completed, as shown at block 250.

As indicated above, a ULM running in a service OS may regularly need to access GPM of VMs. This disclosure describes mechanisms that enable the ULM to access memory that is not managed by the ULM's underlying OS. As has been described, an Xmem device may allow the ULM to access GPM of another VM in a safe and efficient manner. Alternatively, a ULM may be designed to use calls into an underlying VMM kernel to access GPM. However, that kind of approach may be less efficient than using an Xmem device. Moreover, that kind of approach may require more complexity in the VMM kernel and in the ULM.

An Xmem device may also facilitate efficient memory usage by allowing a ULM to dynamically open and close appropriately sized apertures into GPM.

In one embodiment the ULM is presented an abstraction of GPM that is independent of the HPA space. In various embodiments, the ULM may use that GPM abstraction to access memory belonging to another VM, or memory belonging to the hypervisor, and/or data structures in memory external to any VM.

In light of the principles and example embodiments described and illustrated herein, it will be recognized that the described embodiments can be modified in arrangement and detail without departing from such principles. For instance, many operations have been described as using an Xmem device. However, in alternative embodiments, an Xmem file may be used in place of an Xmem device. Alternatively, the capabilities of the Xmem device driver could be implemented in an OS kernel and exposed through an alternate interface.

Also, although the example of FIG. 2 involved a contiguous region of GPM to be accessed by the service VM, in other embodiments the service VM and the Xmem device may access and support multiple, non-contiguous regions of GPM. A contiguous GPM region in a VM can also be created from multiple non-contiguous HPM regions. Also, different hardware arrangements may be used in other embodiments. For instance, the MMU may reside in a different hub, in a CPU, or in any other suitable location within the processing system.

Also, although the foregoing discussion has focused on particular embodiments, other configurations are contemplated as well. Even though expressions such as “in one embodiment,” “in another embodiment,” or the like may be used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine-accessible media containing instructions for performing the operations of the invention. Such embodiments may also be referred to as program products. Such machine-accessible media may include, without limitation, storage media such as floppy disks, hard disks, CD-ROMs, ROM, and RAM, and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing functionality such as that described and illustrated herein. The hardware, software, or combinations of hardware and software for performing the operations of the invention may also be referred to as logic or control logic.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. A method to enable a user level monitor to access memory that belongs to a guest virtual machine, the method comprising:
associating a pseudo-device driver with a portion of a virtual address space of a user level monitor (ULM);
detecting, at the ULM, an operation that involves a physical address space of a guest virtual machine (VM); and
in response to detecting the operation, using the portion of the virtual address space of the ULM associated with the pseudo-device driver to access the physical address space of the guest VM.

2. A method according to claim 1, wherein the ULM operates within an environment from the group consisting of:
a service VM; and
a host operating system (OS).

3. A method according to claim 2, further comprising:
the ULM requesting a hypervisor to make the memory of the guest VM visible to the service VM.

4. A method according to claim 1, further comprising:
mapping an address within the physical address space of the guest VM to an address within the virtual address space of the ULM.

5. A method according to claim 1, further comprising:
mapping an address within the physical address space of the guest VM to an address within the virtual address space of the ULM; and
before mapping the address within the physical address space of the guest VM to the address within the virtual address space of the ULM, determining whether the ULM is authorized to access memory outside the physical address space of the ULM.

6. A method according to claim 1, further comprising:
configuring at least one address translation table for the ULM to map at least part of the physical address space of the guest VM to at least part of the virtual address space of the process in the ULM.

7. A method to enable a user level monitor to access memory that belongs to a guest virtual machine, the method comprising:
detecting, at a user level monitor (ULM), an operation that involves a physical address space of a guest virtual machine (VM); and
in response to detecting the operation, using a virtual address space of the ULM to access the physical address space of the guest VM.

8. A method according to claim 7, further comprising:
mapping an address within the physical address space of the guest VM to an address within the virtual address space of the ULM.

9. A method according to claim 7, further comprising:
configuring at least one address translation table for a service operating system (OS) to map at least part of the physical address space of the guest VM to at least part of the virtual address space of the ULM.

10. A method according to claim 7, wherein the operation of using the virtual address space of the ULM to access the physical address space of the guest VM comprises:
sending a request involving an address within the physical address space of the guest VM from the ULM to a pseudo-device driver in a service operating system (OS).

11. A method according to claim 7, wherein the operation of using the virtual address space of the ULM to access the physical address space of the guest VM is performed in response to detection of an operation from the group consisting of:
a direct memory access (DMA) operation requested by the guest VM; and
an interrupt triggered by the guest VM.

12. An apparatus, comprising:
a pseudo-device driver to execute in a service operating system (OS); and
a user level monitor (ULM) to execute on top of the service OS, the ULM to use the pseudo-device driver to map an address in a physical address space of a guest VM to an address in a virtual address space of the ULM.

13. An apparatus according to claim 12, comprising:
the ULM to use its virtual address space to access the physical address space of the guest VM.

14. An apparatus according to claim 12, comprising:
the pseudo-device driver to determine whether the ULM is authorized to access memory outside the physical address space of the ULM before mapping the physical address space of the guest VM to the virtual address space of the ULM.

15. An apparatus according to claim 12, comprising:
the pseudo-device driver to cause an address translation table for the ULM to be configured to map at least part of the physical address space of the guest VM to at least part of the virtual address space of the ULM.

16. An apparatus according to claim 12, comprising:
the ULM to detect an operation of the guest VM that involves the physical address space of the guest VM; and
the ULM to use its virtual address space to access the physical address space of the guest VM in response to detecting the operation of the guest VM that involves the physical address space of the guest VM.

17. An apparatus according to claim 16, comprising:
the ULM to use its virtual address space to access the physical address space of the guest VM in response to detecting an operation selecting from the group consisting of:
a direct memory access (DMA) operation requested by the guest VM; and
an interrupt triggered by the guest VM.

18. A manufacture, comprising:
a machine-accessible medium; and
instructions in the machine-accessible medium, wherein the instructions, when executed in a processing system, cause the processing system to perform operations comprising:
detecting, at a user level monitor (ULM), an operation that involves a physical address space of a guest virtual machine (VM); and
in response to detecting the operation, using a virtual address space of the ULM to access the physical address space of the guest VM.

19. A manufacture according to claim 18, wherein the instructions cause the processing system to perform further operations comprising:
mapping an address within the physical address space of the guest VM to an address within the virtual address space of the ULM.

20. A manufacture according to claim 18, wherein the instructions cause the processing system to perform further operations comprising:
mapping an address within the physical address space of the guest VM to an address within the virtual address space of the ULM; and
before mapping the address within the physical address space of the guest VM to the address within the virtual address space of the ULM, determining whether the ULM is authorized to access memory outside the physical address space of the ULM.

21. A manufacture according to claim 18, wherein the instructions cause the processing system to perform further operations comprising:
configuring an address translation table for the ULM to map at least part of the physical address space of the guest VM to at least part of the virtual address space of the ULM.

22. A manufacture according to claim 18, wherein:
at least some of the instructions, when executed in a service operating system (OS), implement a pseudo-device driver; and
the operation of using the virtual address space of the ULM to access the physical address space of the guest VM comprises sending a request involving an address within the physical address space of the guest VM from the ULM to the pseudo-device driver in the service OS.

23. A processing system, comprising:
a guest virtual machine (VM) having a physical address space;
a service operating system (OS);
a user level monitor (ULM) running on top of the service OS, the ULM having a virtual address space; and
a pseudo-device driver in the service OS, the pseudo-device driver to enable the ULM to use the virtual address space of the ULM to access an address within the physical address space of the guest VM.

24. A processing system according to claim 23, comprising:
the pseudo-device driver to map an address within the physical address space of the guest VM to an address within the virtual address space of the ULM.

25. A processing system according to claim 23, comprising:
the pseudo-device driver to map an address within the physical address space of the guest VM to an address within the virtual address space of the ULM; and
the pseudo-device driver to determine whether the ULM is authorized to access memory outside the physical address space of the ULM, before mapping the address within the physical address space of the guest VM to the address within the virtual address space of the ULM.

26. A processing system according to claim 23, comprising:
the pseudo-device driver to configure at least one address translation table of the service OS to map at least part of the physical address space of the guest VM to at least part of the virtual address space of the ULM.

27. A processing system according to claim 23, comprising:
the ULM to use the pseudo-device driver to access the physical address space of the guest VM in response to detection of an operation selecting from the group consisting of:
a direct memory access (DMA) operation requested by the guest VM; and
an interrupt triggered by the guest VM.
